(19) United States
(12) Patent Application Publication
(10) Pub. No.: US 2026/0129592 A1
(43) Pub. Date: May 7, 2026

(54) METHODS FOR SIDELINK COMMUNICATION, RELATED WIRELESS DEVICES AND A RELATED NETWORK NODE

(71) Applicant: Sony Group Corporation, Tokyo (JP)

(72) Inventors: Johan HILL, Lund (SE); Torgny PALENIUS, Barsebäck (SE)

(21) Appl. No.: 19/114,440

(22) PCT Filed: Oct. 2, 2023
(86) PCT No.: PCT/EP2023/077218

§ 371 Date: Mar. 22, 2025

(30) Foreign Application Priority Data
Oct. 13, 2022 (SE) 2251202-4

(51) Int. Cl. H04W 52/36; H04W 52/24; H04W 64/00; H04W 92/18

(52) U.S. Cl. CPC H04W 52/367; H04W 52/242; H04W 64/00; H04W 92/18

(57) ABSTRACT

A method is disclosed, performed by a first wireless device, WD, for sidelink communication. The first WD is within a first sidelink group of a plurality of sidelink groups. The method comprises receiving a power signal indicative of a power level for sidelink communication within the first sidelink group. The method comprises transmitting a sidelink signal within the first sidelink group, wherein the sidelink signal is transmitted according to the power level.

The present disclosure pertains to the field of wireless communications. The present disclosure relates to methods for sidelink communication, related first and second wireless device, a method for enabling sidelink communication and a related network node.

### BACKGROUND

The 3rd Generation Partnership Project, 3GPP, Release 17, sidelink enhancements are in the process of being developed. Sidelink and/or sidelink communication refers to device to device (D2D) communication between a plurality of wireless devices (WDs). Sidelink has been developed since release 12 for 3GPP Long Term Evolution (LTE) and has been evolved since then for LTE usage. The interface between the devices is called PC5 (see TS 38.300) and the service layer supporting D2D is called Proximity-based services (ProSe) as specified in TS 23.303.

For 3GPP New Radio (NR) the primary D2D focus has been use cases for vehicle to anything (V2X). Such D2D features have been specified and evolved since NR release 16. The focus has been on typical V2X use cases such as platooning, remote driving, advanced and coordinated driving features, sharing sensor data between vehicles and pedestrians etc. However, in future releases use cases other than V2X likely will be considered.

In LTE only broadcasted sidelink transmissions, such as transmissions between all WDs connected to a sidelink cluster, are supported. Accordingly, all WDs in the sidelink cluster receive the sidelink transmissions, which may lead to a waste of resources and a high power consumption in a wireless communications network in the case the information broadcasted in the sidelink is not relevant to all WDs in the sidelink cluster.

To overcome the above mentioned drawbacks, sidelink groups may be introduced in which WDs may grouped in one or more sidelink groups based on for example their geographical location. Thereby, information relevant to the geographical area may only be broadcasted to WDs within the group, which may reduce the required resources and/or the power consumption. However, WDs within a first sidelink group may experience interference from signals broadcasted within a second sidelink group, such as a sidelink group associated with a geographical area adjacent to the geographical area associated with the first sidelink group.

### SUMMARY

Accordingly, there is a need for devices and methods for sidelink communication, which may mitigate, alleviate, or address the shortcomings existing and may provide reduced interference between sidelink groups.

A method is disclosed, performed by a first wireless device, WD, for sidelink communication. The first WD is within a first sidelink group of a plurality of sidelink groups. The method comprises receiving a power signal indicative of a power level for sidelink communication within the first sidelink group. The method comprises transmitting a sidelink signal within the first sidelink group, wherein the sidelink signal is transmitted according to the power level.

Further, a first wireless device is provided, the first wireless device comprising memory circuitry, processor circuitry, and a wireless interface, wherein the first wireless device is configured to perform any of the methods disclosed herein and relating to the first wireless device.

It is an advantage of the present disclosure that the first wireless device, such as a source wireless device within the first sidelink group, can be instructed to adjust its output power for sidelink transmissions within the first sidelink group to reach all wireless devices within the first sidelink group while ensuring that the power level at a wireless device outside the first sidelink group, such as a WD within a second sidelink group, is low enough to not cause interference. The first wireless device may for example be instructed to restrict the output power specifically for a groupcast or a unicast within a sidelink group in a scenario of geographically constrained areas for the groupcast and/or unicast, such as the groupcast and/or unicast is performed within a sidelink group associated with a geographical area. This provides a sidelink group signaling where the signal will reach with sufficient quality to the edge of the group but being weak outside the boundaries of the sidelink group. This allows additional second sidelink groups to be defined in direct connection with the first sidelink group and utilizing the same physical channel resources as the first sidelink group without experiencing interference. By adjusting the output power there will be less resource conflicts, such as more available resources, when WDs in neighboring sidelink groups perform sensing for transmission. This improves the channel quality within the communications network and allows for a more efficient use of resources. Furthermore, irrelevant information reaching WDs outside the sidelink group of the first wireless device may be reduced.

A method is disclosed, performed by a network node, for enabling sidelink communication. The method comprises receiving position information indicative of a position of one or more wireless devices, WDs, associated with the first sidelink group. The method comprises determining, based on the position information, a power level for sidelink communication within the first sidelink group. The method comprises transmitting, to a first WD of the one or more WDs within the first sidelink group, a power signal indicative of the power level for sidelink communication within the first sidelink group.

Further, a network node is provided, the network node comprising memory circuitry, processor circuitry, and a wireless interface, wherein the network node is configured to perform any of the methods disclosed herein and relating to the network node.

It is an advantage of the present disclosure that the network node can instruct a first wireless device within a first sidelink group to adjust its output power to reach all wireless devices within the first sidelink group while ensuring that the power level at a wireless device outside the first sidelink group, such as a wireless devices within a second sidelink group, is low enough to not cause interference. The network node may determine the appropriate power level based on position information of the first wireless device and/or one or more second wireless devices being associated with the first sidelink group, and/or based on feedback from one or more second wireless devices. Thereby, the network node can accurately determine the allowed and/or required power for sidelink signaling ensuring that all wireless devices within the sidelink group are reached without causing interference outside the sidelink group. The network node may then instruct the first wireless device to, for example, restrict and/or increase the output power specifically for a groupcast or a unicast within the first sidelink group in a scenario of geographically constrained areas for the groupcast and/or unicast, such as when the groupcast and/or unicast is performed within a sidelink group associated with a geographical area. This will provide a sidelink group signaling where the signal will reach with sufficient quality to the edge of the group but being weak outside the boundaries of the sidelink group. Thereby, additional second sidelink groups can be defined in direct connection with the first sidelink group and utilizing the same physical channel resources as the first sidelink group without experiencing interference. By instructing the first wireless device to adjust its output power there will be less resource conflicts, such as more available resources, when wireless devices in neighboring sidelink groups perform sensing for transmission. This improves the channel quality within the communications network and allows for a more efficient use of resources. Furthermore, irrelevant information reaching wireless devices outside the sidelink group of the first wireless device may be reduced.

A method is disclosed, performed by a second wireless device, WD, for sidelink communication. The method comprises receiving, from a first WD, a sidelink signal. The method comprises sending, to a network node, a feedback signal indicative of a power of the received sidelink signal.

Further, a second wireless device is provided, the second wireless device comprising memory circuitry, processor circuitry, and a wireless interface, wherein the second wireless device is configured to perform any of the methods disclosed herein and relating to the second wireless device.

It is an advantage of the present disclosure that the second wireless device can enable the network node to determine an appropriate power level for sidelink signaling from the first wireless device, which power level ensures that all wireless devices within the sidelink group are reached without causing interference outside the sidelink group. The network node may then instruct the first wireless device to adjust, such as restrict and/or increase, the output power or groupcast or unicast signaling within the first sidelink group in a scenario of geographically constrained areas for the groupcast and/or unicast, such as when the groupcast and/or unicast is performed within a sidelink group associated with a geographical area. The second wireless device thus enables the first wireless device to perform sidelink group signaling where the signal will reach to the edge of the group with sufficient quality, while being weak outside the boundaries of the sidelink group. Thereby, additional second sidelink groups can be defined in direct connection with the first sidelink group and utilizing the same physical channel resources as the first sidelink group without experiencing interference. By enabling the network node to determine an appropriate power level for sidelink signaling from the first wireless device, there will be less resource conflicts, such as more available resources, when wireless devices in neighboring sidelink groups perform sensing for transmission. This improves the channel quality within the communications network and allows for a more efficient use of resources. Furthermore, irrelevant information reaching wireless devices outside the sidelink group of the first wireless device may be reduced.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example first wireless device, an example second wireless device, and an example core network node according to this disclosure,

FIG. 2 is a signaling diagram illustrating an example message exchange between a first WD, a network node, a core network node, and one or more second WDs according to this disclosure,

FIG. 3 is a signaling diagram illustrating an example message exchange between a first WD and one or more second WDs comprised according to this disclosure,

FIG. 4 is a flow-chart illustrating an example method, performed in a first wireless device, for sidelink communication according to this disclosure,

FIG. 5 is a flow-chart illustrating an example method, performed in a network node of a wireless communication system, for enabling sidelink communication according to this disclosure,

FIG. 6 is a flow-chart illustrating an example method, performed in a second wireless device, for sidelink communication according to this disclosure,

FIG. 7 is a block diagram illustrating an example first wireless device according to this disclosure,

FIG. 8 is a block diagram illustrating an example network node according to this disclosure, and

FIG. 9 is a block diagram illustrating an example second wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

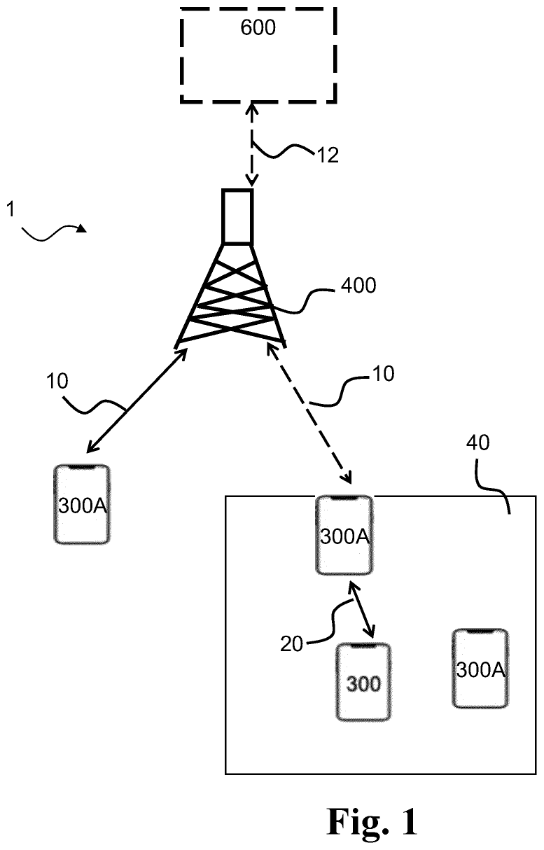

FIG. 1 is a diagram illustrating an example wireless communication system 1 comprising an example radio network node 400 and an example wireless device (WD) 300 according to this disclosure. The wireless communication system 1 optionally comprises an example core network node 600.

As discussed in detail herein, the present disclosure relates to a wireless communication system 1 comprising a cellular system, for example, a 3GPP wireless communication system.

A radio network node 400 disclosed herein refers to a network node operating in the radio access network (RAN), such as a base station, an evolved Node B, eNB, gNB in NR. In one or more examples, the RAN node is a functional unit which may be distributed in several physical units.

A core network, CN, node 600 disclosed herein refers to a network node operating in the core network, such as in the Evolved Packet Core Network, EPC, and/or a 5G Core Network, 5GC. Examples of CN nodes include a Mobility Management Entity (MME), an Access and Mobility Management Function (AMF), a Location Management Function (LMF). A CN node implementing the LMF may herein be referred to as a location network node or a location server (LS). In one or more examples, the CN node 600 is a functional unit which may be distributed in several physical units.

The wireless communication system 1 described herein may comprise one or more wireless devices, such as a first wireless device 300, one or more second wireless devices 300A, and/or one or more radio network nodes 400, such as one or more of: a base station, an eNB, a gNB and/or an access point.

A wireless device may refer to a mobile device and/or a user equipment (UE).

The wireless device 300, 300A may be configured to communicate with the radio network node 400 via a wireless link (or radio access link) 10, 10A, such as a Universal Mobile Telecommunications System air (Uu) interface.

The core network node 600 may be configured to communicate with the radio network node 400 via a link 12, such as a wired and/or wireless link, and/or with the one or more wireless devices 300, 300A, via the radio network node 400.

The wireless devices 300, 300A may be configured to communicate directly with each other via a sidelink 20, such as without communicating via the radio network node 400.

The sidelink 20 may be a wireless link, such as a wireless link via a PC5 interface. The first wireless device 300 may, in one or more examples, be a source WD, such as a wireless device transmitting a signal over the sidelink. The second wireless device 300A may, in one or more examples, be a target WD, such as a wireless device transmitting a signal over the sidelink. In one or more examples, one or more of the one or more second wireless devices 300A may be within a sidelink group with the first WD 300, such as within a first sidelink group 40. In one or more examples, one or more of the one or more second wireless devices 300A may be outside the sidelink group.

A network node as disclosed herein may refer to a CN node, such as CN node 600, or a radio network node, such as radio network node 400.

3GPP NR supports a plurality of different cast types, such as Unicast, Broadcast and Groupcast. Unicast can herein be seen as a direct communication between WD to WD. Broadcast can herein be seen as a WD broadcasting data to all WDs in range of decoding the transmitted data. Groupcast can herein be seen as a WD groupcasting data to a specific set of WDs belonging to a group of WDs.

A WD 300, 300A configured for sidelink communication may be configured with a ProSe UE ID which may be used to identify the receiver when a signal is sent to the WD. Since 3GPP NR D2D communication also supports groupcast, a group of WDs may have its dedicated group ID, which may be referred to as ProSe Layer-2 Group ID which is used in a data transmission when the WD sends data to the group of WDs. Currently the management of the WD belonging to a group is handled in the application layer, while the configuration of the group is handled in a Radio Resource Control (RRC) layer. Handled in the application layer can herein be seen as the management of the WDs belonging to the group being performed in an application function and being signaled from the application layer. Groupcast can herein be seen as communication between all WDs belonging to a group, such as to a sidelink group.

Example use cases for groupcast include vehicle platooning and extended sensors. In the case of extended sensors, sensor information may be exchanged through a lower latency vehicular network where vehicles, pedestrians and/or other type of users share their data in groups interested in the particular data. In the case of platooning, vehicles may follow each other tightly with reduced safety margins enabled by shared information among the vehicles in a vehicular network. A master WD of the platoon of WDs, such as a lead vehicle of the platoon, may multicast, such as groupcast and/or broadcast, commands in the sidelink to control the platoon. Broadcasting can herein be seen as communication between all WDs connected to a sidelink cluster, such as to a communication area in which the sidelink configuration is valid. The master WD may be seen as a WD leading and/or controlling the set of WDs in the sidelink group.

According to the current disclosure, a sidelink group may be defined by a set of WDs, such as one or more WDs 300, 300A, which are associated with, such as located within, a geographical area 40, such as a predetermined geographical area. A predetermined geographical area can be seen as a geographical area defined by a fixed set of geographical coordinates. In one or more example methods, the set of WDs may be defined directly by the network, such as by a network node. In one or more example methods, the set of WDs may be defined by a WD telling, such as signaling, group information, such as the geographical area of the group and/or the WDs comprised in the group to the network. The network may maintain, such as stores, that information (e.g., in a private network). In one or more example methods the set of WDs 300, 300A may be a preconfigured set of WDs. The preconfigured set of WDs may be provided as a list of unique WD identifiers identifying each WD comprised in the sidelink group. The preconfigured set of WDs may for example be WDs belonging to workers, or vehicles at for example a workplace, such as a factory or an office building. In one or more examples, a company may provide the pre-configuration to employees so that WDs associated with the employees, such as used by the employees, can connect to a sidelink service of the company when at work. The geographical area 40 may, in one or more example methods, be defined by a footprint of a building, such as of the factory and/or the office. A geographical area may herein be defined as a two-dimensional geographical aera, having a width and a length. For example, a geographical area can herein be seen as an area of the earth, such as a city, a region, a building block, and/or one or more buildings. In one or more example methods, the geographical area may be defined by its vertical position, such as based on a floor of a building. The particular dimensions of the geographical area are not limiting, and any type of regular and/or irregular polygonal area can be used. The geographical area may be a pre-set, such as a predetermined, area. The geographical area may be set via user input. One or more WDs in the geographical area may be configured to set the geographical area. In one or more example methods, such as when the set of WDs are a set of platooning vehicles, the geographical area is a moving area centered around a vehicle in the platoon, such as centered around the master vehicle of the platoon. Coordinates of the geographical area associated with the set of WDs may thus change over time. In one or more example methods, a border of the geographical area may be defined by positions of the outer WDs comprised in the sidelink group, such as be defined by imaginary lines drawn between a plurality of the WDs in the sidelink group and encompassing the remaining WDs in the sidelink group. In one or more example methods, the sidelink group may be defined based on a speed and/or a direction of the WDs. For example, if a plurality of WDs are moving with the same or similar speed(s) in the same or similar direction(s), the WDs may be determined to belong to the same sidelink group, such as to a platooning group of vehicles.

In one or more example methods, a first sidelink group may be defined by a set of WDs located in one or more specific building(s). In one or more example methods, a second sidelink group may be defined by a set of WDs located on one or more specific floors in the specific building, such as for example on a third and/or a second floor of the specific building. In other words, the geographical area may herein be seen as an area having three dimensions, such as a length, a width, and a height. The geographical area may, in one or more example methods, be within a factory, an office, an arena, or in lower coverage area occasionally having a larger amount of WDs, such as a remote area where for example a rally or a bicycle race takes place. In this geographical area 40, a plurality of WDs 300, 300A, such as some or all the WDs 300, 300A located in the geographical area 40, may belong to the same sidelink group, such as to the same sidelink multicast group. When a WD 300, 300A is leaving the geographical area 40, the WD 300, 300A may be removed as a member of the sidelink group associated with the geographical area. The WD 300, 300A leaving the geographical area may thus not be member of the sidelink group associated with the geographical area anymore.

In one or more example methods, sidelink groups associated with the geographical area 40, herein also referred to as geographical sidelink groups, may be used for spreading information within the geographical area 40. In one or more example methods, sidelink groups associated with the geographical area 40 may be used to relay information when a WD 300, 300A of the sidelink group is out of coverage, such as when the WD 300, 300A is located in an area having limited coverage, such as in a basement. The information may for example be relayed using a plurality of WDs 300, 300A, such as forwarding the information via a number of WDs in the sidelink group. Relaying the information via a plurality of WDs 300, 300A may herein also be referred to as multi-hop routing. In multi-hop routing the network coverage area can be larger than the radio range of single nodes, such as of single WDs. Therefore, to reach a receiving node, such as a receiving WD, located outside of the radio range of the source node, such as of a source WD, other nodes, such as other WDs, may be used as relay nodes. Every step of a chain of relay nodes can herein be referred to as a hop. A hop can herein be seen as a retransmission of a transmitted signal at a relay node. In other words, if a signal is transmitted from a source node to a relay node which retransmits the signal to the receiver node, the communication may be referred to as a two-hop communication. The first hop being the transmission from the source node to the relay node and the second hop being the transmission from the relay node to the receiver node. In one or more example methods, a first WD, such as the source node, may be configured to transmit with a different power than the relay node a relay WD, such as a relay WD. For example, in case the first WD is not able to reach the entire geographical area 40 the first WD may request one or more relay nodes, such as one or more first hop receivers, such as relay WDs, to retransmit the transmission. In this case since the first hop receivers are typically located closer to the first WD than the border of the geographical area, the first WD may be configured to reduce its power while still ensuring that the transmission reaches the entire geographical area 40 due to being retransmitted by the first hop receivers. The first hop receivers, which can be seen as second hop transmitters when retransmitting the transmission, may be configured with a different power level than the first WD to reach the entire geographical area 40, such as reach the edges of the geographical area 40. In other words, the relay nodes may receive a power signal indicative of a different power level for sidelink communication within the first sidelink group than the first WD, such as the source WD, during multi-hop routing. It can also be used on Internet of Things (IoT) devices with positioning capability, such as on tags on items which are detected and tracked once they are entering a factory. In, for example, a factory geographical sidelink groups can be used for local traffic information between WDs, such as vehicles, in the factory. The vehicles in the factory may for example be fork-lifts, industrial trucks, and/or transportation robots moving within the factory. Since these vehicles have an operation of service within a limited area of the industrial facility, there is no reason to spread information, such as the local traffic information, to sidelink capable WDs that are located outside the geographical area, such as the factory, associated with the sidelink group. By associating the WDs 300A located within the predetermined geographical area 40 with a specific sidelink group, such as a geographical sidelink group, the communication, such as the spreading of information, can be limited to the WDs comprised in the predetermined geographical area. When the geographical area is a predetermined geographical area, such as a geographical area defined by a fixed set of geographical coordinates, the wireless communication network may provide, such as transmit, information to all WDs being within the geographical area without having to know exactly which WDs, such as the identity of the WDs, being inside the predetermined geographical area. This may increase safety, for example when transmitting warning messages to WDs within the geographical area.

In one or more examples, WDs 300, 300A located within a geographical area having poor 3GPP coverage, such as WDs 300, 300A located in a mall having poor 3GPP coverage, can act as relay nodes for WDs 300, 300A further inside the geographical area and being without coverage.

The WDs 300, 300A comprised in the sidelink group may, in one or more example methods, be defined by a list of WDs, each WD being defined by a respective WD identity, such as a 3GPP Layer 2 (L2) identity. The L2 identity may for example be signaled in a sl-SourceIdentity-RemoteUE field using RRC signaling in the RAN. This field can be used to indicate the Source Layer-2 ID to be used to establish a sidelink, such as a PC5 link, with a L2 UE-to-network (U2N) relay UE. The sidelink group may be defined by the geographical area it is associated with. In other words, the sidelink group is made up of, such as comprises, the WDs located in the geographical area and being capable of communicating via sidelink 20 are comprised in the sidelink group. When a new WD enters the geographical area associated with the sidelink group, the identity, such as the L2 identity, of the WD may be added to the list of WDs defining the sidelink group. This may be done according to 3GPP TS 23.287, section 6.3.2.

There are two types of power control mechanisms typically specified in 3GPP based technologies like e.g., LTE and NR. These two types of power control are commonly referred to as open-loop power control and closed-loop power control. In the open-loop power control, the output power at a transmitting wireless device is controlled based on an estimated reference signal value without feedback from a receiving network node of the transmission, such as from a receiving gNB. In closed-loop power control, the transmitting wireless device receives feedback on the power of the transmission from the receiving network node and may adapt the output power of the transmission based on this feedback. For sidelink transmissions only an open-loop power control is currently specified by 3GPP. In other words, a receiving WD cannot directly inform a transmitting WD to increase or decrease the transmission power level.

The current disclosure provides a solution for controlling a transmitted output power within a sidelink group to enable a use of denser sidelink group allocations geographically wise and to avoid interference, such as interference between the sidelink groups. Denser sidelink group allocation can herein be seen as allowing the sidelink groups to be allocated closer to each other geographically, such as arranging the edges of the sidelink groups closer to each other in space.

According to one or more example scenarios, there are two or several sidelink groups, such as geographical sidelink groups, defined as neighbors. One way to manage interference is by not scheduling source WDs of each group to transmit simultaneously. However, according to the current disclosure, the source WDs can transmit simultaneously and can be configured to lower their output power to a power level high enough to just reach the WDs on an edge of the sidelink group.

According to the current disclosure, the output power may be restricted for a groupcast within a sidelink group, such as for geographically constrained sidelink group, such as in the scenario of geo-constrained areas for the groupcast. This allows a signal transmitted by a first WD of a first sidelink group, such as a source WD of the first sidelink group, to reach the edge of the first sidelink group with sufficient quality for the WDs comprised in the first sidelink group but will be weak outside the boundaries of the first sidelink group to not cause interference with WDs not within the first sidelink group, such as WDs within a second sidelink group. This will enable to have additional second groups defined in direct connection, such as sharing borders and or having a border in the vicinity of the first sidelink group while utilizing the same physical channel resources as the first sidelink group without causing interference between the first sidelink group and the one or more second sidelink groups.

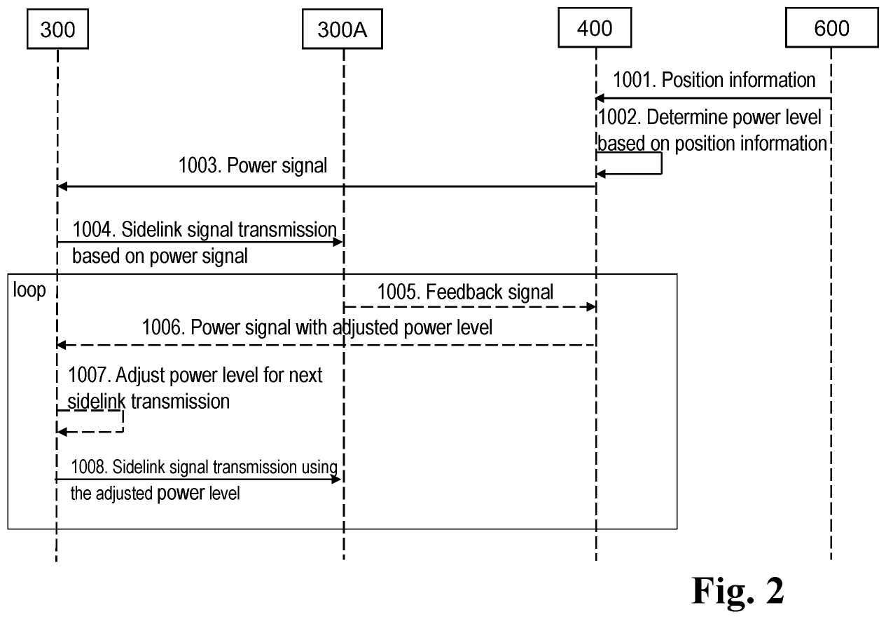

FIG. 2 shows a signaling diagram illustrating an example message exchange between a first WD 300, one or more second WDs 300A, a network node 400 and a core network node 600 according to the current disclosure. The core network node may be a positioning node, such as a location management function (LMF) node. In one or more example methods, the first WD 300 and the one or more second WDs 300A are comprised in a same sidelink group, such as in a first sidelink group.

The network node 400 may receive position information 1001 indicative of a position of one or more WDs. The one or more WDs may be WDs associated with the first sidelink group. The one or more WDs may be the first WD 300 and/or the one or more second WDs 300A. The position information 1001 may, in one or more example methods, comprise information indicative of a position and/or a location of the first WD 300, such as of a source WD of the first sidelink group. A position can herein be seen as a relative position to a second object. A location can herein be seen as an actual geographical coordinate. In one or more example methods, the position information 1001 may comprise information about a geographical area associated with the first sidelink group, such as a size of the geographical area and/or a distance from the first WD 300 to an edge and/or border of the geographical area, and/or to one or more second WDs 300A. The position information may, in one or more example methods, comprise a sidelink group identifier (ID) for identifying the first sidelink group associated with the geographical area. The position information may be received using control signaling. In the example shown in FIG. 2, the network node 400 receives the position information from the core network node 600, such as from the LMF.

Based on the position information, such as the position of the first WD 300, such as of the source WD, the network node 400 may determine, such as calculate, a power level for sidelink transmissions by the first WD 300. The network node 400 may, for example calculate pathloss values and use the calculated pathloss values to calculate a pathloss to geographical location boundaries as start value. The geographical location boundaries can herein be seen as a location of one or more of the one or more second WDs in the first sidelink group, and/or to an edge of the geographical area associated with the first sidelink group. The geographical location boundaries may be obtained by the one or more second WDs 300A providing their respective coordinates and/or the core network node 600 providing the coordinates of the one or more second WDs 300A and/or the edge of the geographical area associated with the first sidelink group. In one or more example methods, the power level, such as an output power restriction and/or an output power requirement, may be based on the geographical area, by determining what the maximum expected pathloss is given the one or more second WDs 300A, such as one or more target WDs, could be anywhere in this geographical area.

The network node 400 may send a power signal 1003 indicative of the power level for sidelink communication within the first sidelink group to the first WD 300. The power level may be a power level specific for each sidelink group, such as for the first sidelink group. The power signal may, in one or more example methods, comprise a sidelink group identifier for identifying the sidelink group for which the indicated power level applies. The power signal may be transmitted using control signaling.

The first WD 300 transmits a sidelink signal 1004 to the one or more second WDs 300A based on the power signal, such as by transmitting the sidelink signal using the power level indicated in the power signal 1003.

In one or more example methods, one or more second WDs 300A may transmit a feedback signal 1005 to the network node 400. The feedback signal 1005 may be indicative of a power of a received signal, such as of the received sidelink signal, from the first WD 300A. The power of the received signal may for example be a Reference Signal Received Power (RSRP). In one or more example methods, the feedback signal 1005 may indicate that the received sidelink signal is too weak for a second WD 300A, such as when the second WD 300A is within the coordinates of the geographical area associated with the first sidelink group. This may for example be the case when the feedback signal is transmitted by a second WD 300A comprised within the first sidelink group. The feedback signal may be transmitted using control signaling. In one or more example methods, the feedback signal 1005 may indicate that the received sidelink signal is too strong for and/or interferes with a second WD 300A. This may be the case when the second WD 300A transmitting the feedback signal is outside the coordinates of the geographical area associated with the first sidelink group and/or is not within, such as is outside, the first sidelink group. The feedback signal may thus be an interference signal transmitted by a second WD 300A outside the first sidelink group. In one or more example methods, the feedback signal 1005 may comprise the sidelink group ID associated with the first WD 300 transmitting the sidelink signal and/or the second WD 300A receiving the sidelink signal.

In one or more example methods, the network node 400 may determine an adjusted power level for sidelink transmission within the first sidelink group based on the feedback signal 1005. The network node 400 may transmit a power signal 1006 indicative of the adjusted power level for sidelink transmissions to the first WD 300. The power signal 1006 may indicate that the first WD 300 is to adjust the power level, such as the output power, by increasing or decreasing the power level for sidelink transmissions. The sidelink transmissions may, in one or more example methods, be sidelink transmissions to the one or more second WDs 300A when the first WD 300 is inside the coordinates of the sidelink group.

The first WD 300 may adjust 1007 the power level for the next sidelink transmission and may transmit sidelink transmissions to second WDs 300A within the first sidelink group.

This signaling 1005 to 1008 may provide a closed-loop feedback solution for controlling the output power for sidelink transmissions.

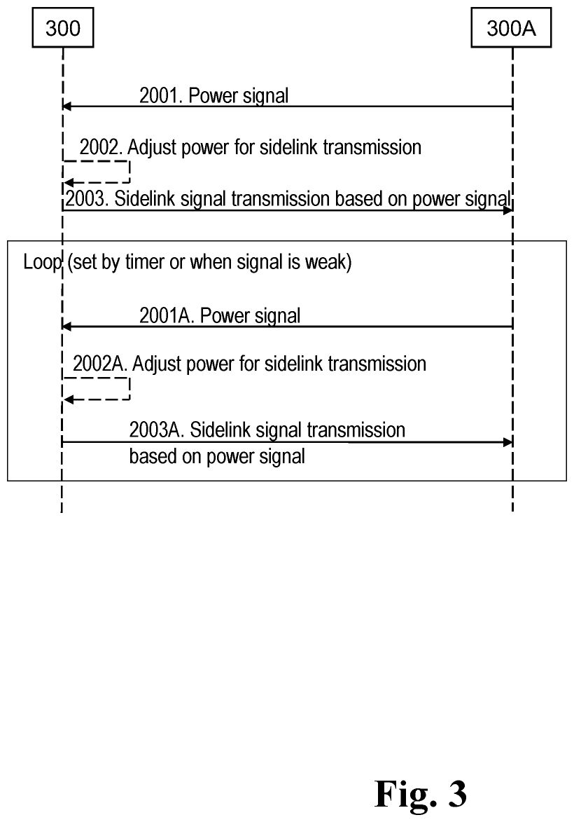

FIG. 3 shows a signaling diagram illustrating an example message exchange between the first WD 300, such as the source WD, and one or more second WDs 300A, such as one or more target WDs, according to the current disclosure. According to the example message exchange in FIG. 3, the first WD 300 may receive the power signal 2001 from one or more second WDs 300A. The power signal 2001 may be a reference signal transmitted by one or more second WDs within the first sidelink group. The reference signal may be transmitted at a known reference power level. The reference signal may be a discovery signal, and/or any other signal being scheduled or spontaneously transmitted, such as a synchronization signal to the first WD. This may be an open loop solution.

The first WD may adjust 2002, such as sets up, its power level, such as its output power, for sidelink transmission within the first sidelink group based on the reference signal received from the one or more second WDs 300A. The first WD 300 may determine a path loss between the first WD and the one or more second WDs based on the power signal received from the one or more second WDs 300A, such as based on the reference signal. The first WD 300 may adjust its power level based on the determined path loss.

The first WD 300 transmit the sidelink signal 2003 based on the power signal 2001, such as based on the adjusted power level 2002 for the sidelink transmission.

In one or more example methods, the signaling 2001, 2002 and 2003 may be looped, such as retransmitted, by performing corresponding signaling 2001A, 2002A, and/or 2003A. In one or more example methods, the signaling 2001, 2002, 2003, 2001A, 2002A, 2002B may be looped, such as retransmitted, with a periodicity, such as based on a set timer. In one or more example methods, the signaling 2001, 2002, 2003, 2001A, 2002A, 2002B may be looped, such as retransmitted, upon the sidelink signal received at the one or more second WDs 300A being weak, such as being equal to or lower than a power threshold.

The power level of the sidelink transmission within the sidelink group may in one or more example methods be determined, and/or calculated, and/or adjusted based on the details and/or equations of power control for sidelink as specified in 3GPP TS 38.213, v. 17.1.0, chapter 16.2. Examples of the equations for determining the power level, such as the output power, over a Physical Sidelink Shared Channel (PSSCH) based on the following equation 1:

$${P}_{PSSCH} ( i ) = min ( {P}_{CMAX} , {P}_{MAX , CBR} , \\ min ( {P}_{PSSCH , D} ( i ) , {P}_{PSSCH , SL} ( i ) ) , {P}_{Geo - Group} ( Group - ID ) ) [ dBm ] \qquad ( Eq . 1 )$$

where
P_{CMAX} and P_{MAX,CBR} are maximum limitations of the output power,
P_{PSSCH,D}(i) is a configured downlink output power,

$${P}_{PSSCH , SL} ( i ) = {P}_{O , SL} + 10 {log}_{10} ( {2}^{μ} \cdot {M}_{RB}^{PSSCH} ( i ) ) + {α}_{SL} \cdot {PL}_{SL} [ dBm ]$$

and is a configured sidelink output power,
P_{Geo-Group}(Group-ID) is an output power for a sidelink group having a group ID,
P_{O,SL}, is an expected received power configured in RRC,
α_{SL} is a pathloss compensation factor configured in RRC,
PL_{SL}=referenceSignalPower−higher layer filtered RSRP, is the path loss for the sidelink,

$${M}_{RB}^{PSSCH} ( i )$$

is a number of resource blocks (RB) for PSCCH-PSSCH transmission occasion i,
μ is a sub-carrier spacing (SCS) configuration, and
i is the transmission occasion.

In other words, the min expression of the equation for determining a power P_{PSSCH} for a PSSCH transmission as specified in 3GPP TS 38.213, v. 17.1.0, section 16.2, can be extended with a third component P_{Geo-Group}(Group-ID) indicative of the sidelink group power.

According to one or more example methods, a negative term PL_{Geo-Group}(Group-ID) indicative of the path loss (PL) in the sidelink group, may be inserted into the expression for P_{PSSCH,SL} of Eq 1, see Eq 2 below:

$${P}_{PSSCH , SL} ( i ) = {P}_{O , SL} + 10 {log}_{10} ( {2}^{μ} \cdot {M}_{RB}^{PSSCH} ( i ) ) + {α}_{SL} \cdot {PL}_{SL} - {PL}_{Geo - Group} ( Group - ID ) \qquad ( Eq . 2 )$$

According to one or more example methods, a configurable value of a maximum allowed configured PL in the sidelink group PL_{Geo-Group}(Group-ID) may be set, and may be inserted into the expression for P_{PSSCH,SL} of Eq 1, see Eq 3 below:

$${P}_{PSSCH , SL} ( i ) = {P}_{O , SL} + 10 {log}_{10} ( {2}^{μ} \cdot {M}_{RB}^{PSSCH} ( i ) ) + max ( {α}_{SL} \cdot {PL}_{SL} , {PL}_{Geo - Group} ( Group - ID ) \qquad ( Eq . 3 )$$

The above equations Eq 1 to Eq 3, covers an open loop power level control scenario. The closed loops part of the power calculations may look different and may use Transmit Power Control Commands (TPC) to gradually increase or decrease the output power based on feedback signals, such as based on measurements, such as RSRP measurements. To provide a closed loop power control system, a power control adjustment state f_{b,f,c}(i,l), similar to the closed loop power control of e.g. a Physical Uplink Shared Channel (PUSCH) as specified in 3GPP TS 38.213, v. 17.1.0, section 7.1.1, can may be added to Eq. 1, in accordance with Eq. 4 below:

$${P}_{PSSCH} ( i ) = min ( {P}_{CMAX} , {P}_{MAX , CBR} , min ( {P}_{PSSCH , D} ( i ) , {P}_{PSSCH , SL} ( i ) ) , \\ {P}_{Geo - Group} ( Group - ID ) ) + {f}_{b , f , c} ( i , l ) [ dBm ] \qquad ( Eq . 4 )$$

$$where$$

$${f}_{b , f , c} ( i , l ) = {f}_{b , f , c} ( i - {i}_{0} , l ) + {\sum }_{m = 0}^{C ( {D}_{i} ) - 1} {δ}_{PSSCH , SL , b , f , c} ( m , l ) .$$

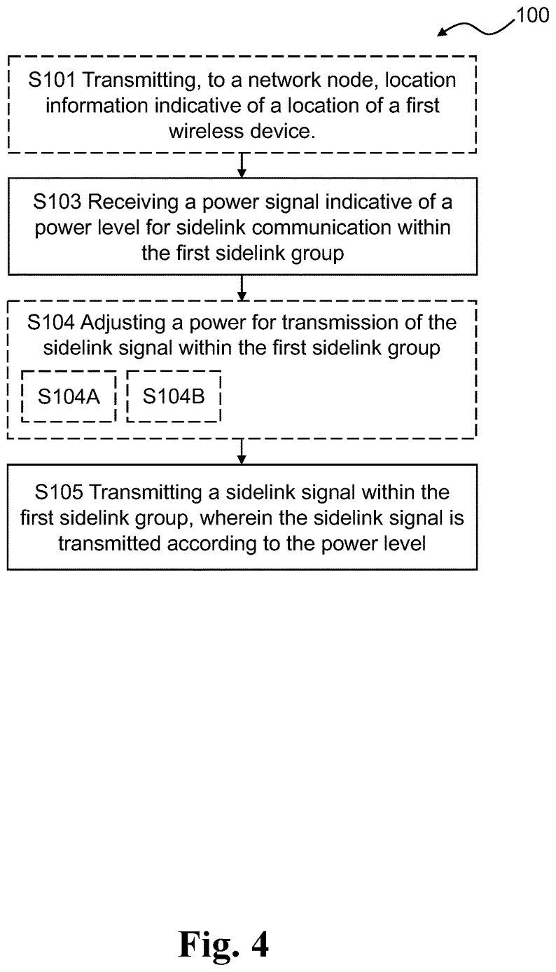

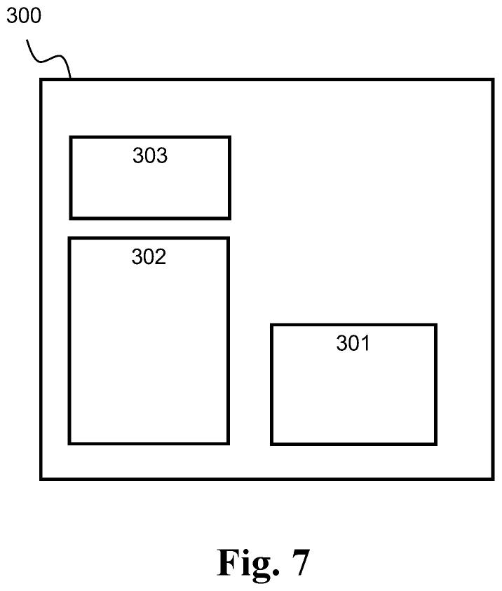

FIG. 4 shows a flow-chart of an example method 100, performed by a first wireless device, WD, according to the disclosure, for sidelink communication. The first WD is in a first sidelink group of a plurality of sidelink groups. The first WD is the first WD 300 of FIG. 1, FIG. 2, FIG. 3 and FIG. 7.

In one or more example methods, the method 100 comprises transmitting S101, to a network node and/or to a core network node, location information indicative of a location of the first wireless device. The location information may in one or more example methods comprise a sidelink group ID associated with the first WD, such as indicating which sidelink group the first WD is comprised in.

The method 100 comprises receiving S103 a power signal indicative of a power level for sidelink communication within the first sidelink group. The sidelink communication within the group may be one or more of a groupcast within the sidelink group, such as within the first sidelink group, and unicast between two WDs within the sidelink group, such as within the first sidelink group. The power level may be one or more of an output power level, a power restriction, such as a maximum output power, and a power requirement, such as a minimum output power. The power level may be specific for the sidelink group of the first wireless device, such as for the first sidelink group of the plurality of sidelink groups. In one or more example methods, the power signal is received from a network node.

In one or more example methods, the power signal is received from a second WD. In one or more example methods, the second WD is comprised within the same sidelink group as the first WD, such as within the first sidelink group. In one or more example methods, the second WD is comprised in a second sidelink group. The second sidelink group may be a sidelink group different than the first sidelink group. In one or more example methods, the power signal is a reference signal. The reference signal may be a signal having a known reference power level, such as a signal being transmitted with a known reference power level. The reference signal may be one or more of a discovery signal, and a synchronization signal.

In one or more example methods, the power signal is a request to adjust a power level, such as an output power, for transmission of the sidelink signal. The request to adjust the power for the sidelink transmission may be a request to increase or to decrease the power level.

In one or more example methods, the power signal is indicative of one or more of an actual power level and a maximum power level for sidelink communication. The actual power level may be indicative of the current power level for sidelink transmissions within the first sidelink group. The maximum power level may be indicative of a maximum power level that the first WD is allowed to use for sidelink transmissions within the first sidelink group. Based on the actual power level and the maximum power level, the first WD may determine an adjustment of the power level for sidelink transmission within the first sidelink group, for example using Eq. 1 disclosed herein.

In one or more example methods, the power signal is indicative of a sidelink group identifier (ID). The sidelink group ID may be associated with, such as assigned to, a specific sidelink group. By the power signal being indicative of the sidelink group ID, the power level can be associated with the specific sidelink group. Sidelink transmissions can thus be transmitted with different power levels in different sidelink groups.

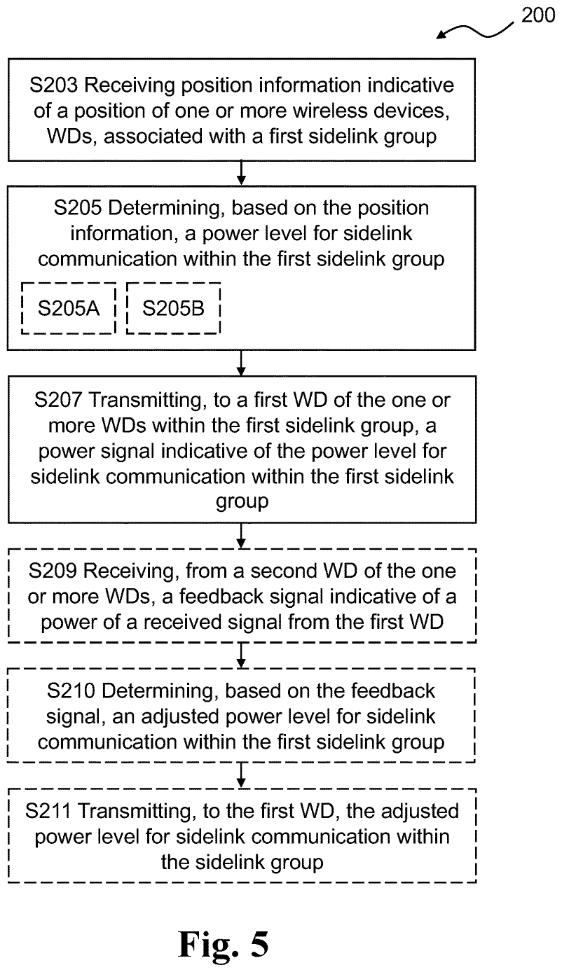

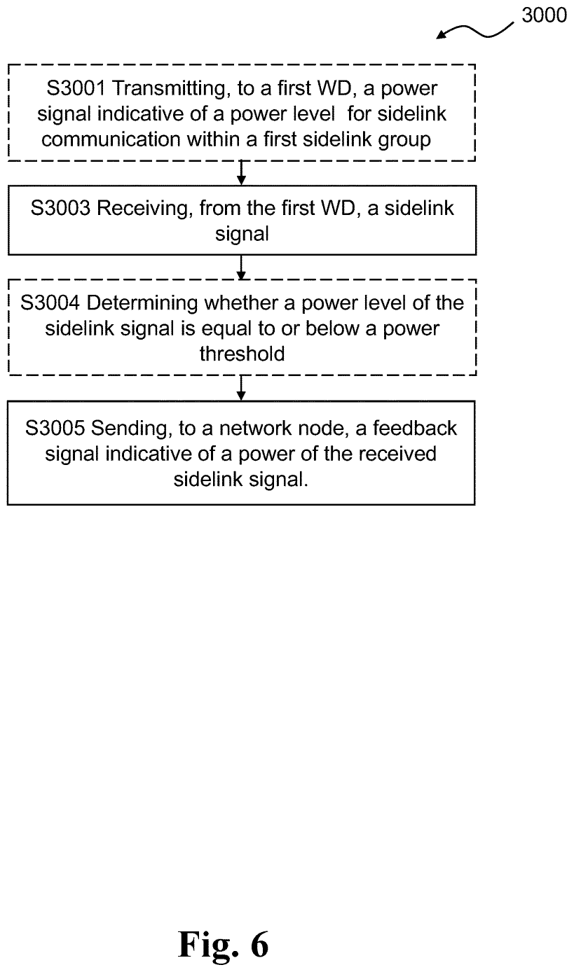

Receiving S103 corresponds to step S207 described in relation to FIG. 5, step S3001 described in relation to FIG. 6, signaling 1003 and/or 1006 described in relation to FIG. 2, and/or signaling 2001 and/or 2001A described in relation to FIG. 3 herein.

In one or more example methods, the method 100 comprises adjusting S104, based on the power signal, a power for transmission of the sidelink signal within the first sidelink group. In one or more example methods, adjusting S104 comprises determining S104A, based on the reference signal, a path loss. The path loss can be seen as the reduction in power density (attenuation) of an electromagnetic wave, such as of the signal, as it propagates through space. The path loss may, in one or more example methods, be an estimated path loss of a signal transmitted from a second WD to the first WD. In one or more example methods, the path loss may be estimated based on a distance between the first WD and the second WD and/or based on a distance from the first WD to a second location, such as to an edge of the geographical area associated with the first sidelink group. In one or more example methods, adjusting S104 comprises adjusting S104B, based on the determined path loss, the power level for sidelink communication within the first sidelink group. The first WD may adjust the power for transmission of the sidelink signal within the first sidelink group based on any one of the equations Eq. 1 to Eq. 4 previously disclosed. The step S104 corresponds to signaling 1007 described in relation to FIG. 2 and signaling 2002, and 2002A described in relation to FIG. 3 herein.

The method 100 comprises transmitting S105 a sidelink signal within the first sidelink group according to the power signal, such as according to the indicated power level. In other words, the first wireless device may transmit sidelink transmissions within the first sidelink group using the adjusted power. The step S105 corresponds to step S3003 described in relation to FIG. 6, signaling 1004 and/or 1008 described in relation to FIG. 2 and signaling 2001 and/or 2001A described in relation to FIG. 3 herein.

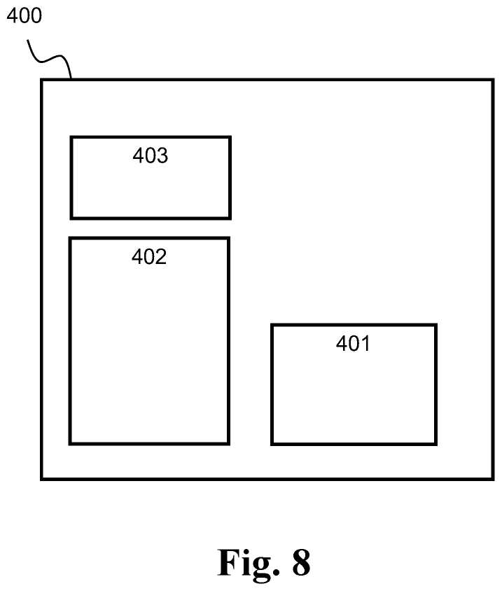

FIG. 5 shows a flow-chart of an example method 200, performed by a network node according to the disclosure, for enabling sidelink communication. The network node is the network node 400 of FIG. 1, FIG. 2, FIG. 3, and FIG. 8.

The method 200 comprises receiving S203 position information indicative of a position of one or more wireless devices, WDs, associated with a first sidelink group. The position information may be one or more of position information of one or more WDs within the first sidelink group, and one or more WDs not within the first sidelink group but being affected by signaling occurring between WDs within the first sidelink group. Being affected by signaling occurring between WDs within the first sidelink group can herein be seen as hearing signaling occurring in the first sidelink group and/or experience interference by signaling occurring within the first sidelink group. In one or more example methods, the one or more WDs not in the first sidelink group may be one or more of one or more WDs within a second sidelink group and/or one or more WDs not comprised in a sidelink group. The step S203 corresponds to step S101 described in relation to FIG. 4 herein, and/or signaling 1001 described in relation to FIG. 2 herein.

The method 200 comprises determining S205, based on the position information, a power level for sidelink communication within the first sidelink group. The step S205 corresponds to signaling 1002 described in relation to FIG. 2 herein.

In one or more example methods, determining S205 comprises calculating S205A, based on the position information, a path loss. Path loss can be seen as the reduction in power density (attenuation) of an electromagnetic wave, such as of the signal, as it propagates through space. The path loss may, in one or more example methods, be an estimated path loss of a signal transmitted from a second WD to the first WD. In one or more example methods, the path loss may be estimated based on a distance between the first WD and the second WD, or based on a distance from the first WD to a second location, such as to an edge of the geographical area associated with the first sidelink group. In one or more example methods, determining S205 comprises determining S205B, based on the calculated path loss, the power level for sidelink communication within the first sidelink group. The power level may for example be determined based on the path loss using Eq. 2 and/or Eq. 3 previously disclosed herein.

The method 200 comprises transmitting S207, to a first WD of the one or more WDs within the first sidelink group, a power signal indicative of the power level for sidelink communication within the first sidelink group. In one or more example methods, the power signal is indicative of one or more of an actual power level and a maximum power level for sidelink communication within the first sidelink group. In one or more example methods, the power signal is indicative of a sidelink group identifier, such as a sidelink group identifier of the first sidelink group. The step S207 corresponds to signaling 1003 described in relation to FIG. 2 herein, and/or step S103 described in relation to FIG. 4 herein.

In one or more example methods, the method 200 comprises receiving S209, from a second WD of the one or more WDs, a feedback signal indicative of a power of a received signal from the first WD. In one or more example methods, the second WD is within the first sidelink group. In one or more example methods, the feedback signal may be indicative of a Reference Signal Received Power (RSRP). In one or more example methods, the second WD is outside the first sidelink group. In one or more example methods, the feedback signal may be, and/or may be indicative of, an interference signal from the second WD outside the first sidelink group. Receiving S209 corresponds to signaling 1005 described in relation to FIG. 2 herein, and/or transmitting 3005 described in relation to FIG. 6 herein.

In one or more example methods, the method 200 comprises transmitting S211, to the first WD, an adjusted power level for sidelink communication within the sidelink group based on the feedback signal. Transmitting S209 corresponds to signaling 1006 described in relation to FIG. 2 herein, and/or receiving S301 described in relation to FIG. 4 herein.

In one or more example methods, the method 200 comprises determining S210, based on the feedback signal, the adjusted power level for sidelink communication within the first sidelink group.

In one or more example methods, the method 200 comprises transmitting S207, to a first WD of the one or more WDs within the first sidelink group, a power signal indicative of the power level for sidelink communication within the first sidelink group. In one or more example methods, the power signal is indicative of one or more of an actual power level and a maximum power level for sidelink communication within the first sidelink group. In one or more example methods, the power signal is indicative of a sidelink group identifier. The step S207 corresponds to signaling 1003 described in relation to FIG. 2 herein, and/or step S103 described in relation to FIG. 4 herein.

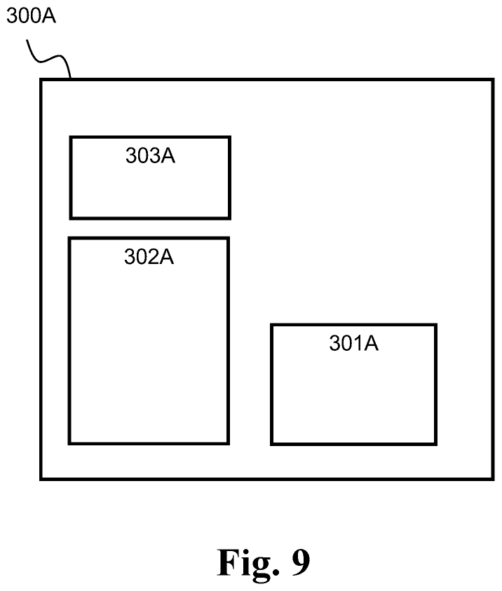

FIG. 6 shows a flow-chart of an example method 3000, performed by a second wireless device, WD, according to the disclosure, for sidelink communication. The second WD is the second WD of FIG. 1, FIG. 2, FIG. 3, and FIG. 9.

In one or more example methods, the method 3000 comprises transmitting S3001, to the first WD, a power signal indicative of a power level for sidelink communication within the first sidelink group. In one or more example methods, the power signal is a reference signal. Transmitting 3001 corresponds to signaling 2001, 2001A described in relation to FIG. 3 herein, and/or receiving S103 described in relation to FIG. 4 herein.

The method 3000 comprises receiving S3003, from a first WD, a sidelink signal. Receiving S3003 corresponds to step S105 described in relation to FIG. 4, signaling 1004 and/or 1008 described in relation to FIG. 2 and signaling 2001 and/or 2001A described in relation to FIG. 3 herein.

In one or more example methods, the method 3000 comprises determining S3004 whether a power level of the sidelink signal is equal to or below a power threshold.

The method 3000 comprises sending S3005, to a network node, a feedback signal indicative of a power of the received sidelink signal. In one or more example methods, the second WD is within the first sidelink group. In one or more example methods, the feedback signal may be indicative of a Reference Signal Received Power (RSRP). In one or more example methods, the second WD is outside the first sidelink group. In one or more example methods, the feedback signal may be, and/or may be indicative of, an interference signal from the second WD outside the first sidelink group. In one or more example methods, the feedback signal is indicative of a sidelink group identifier.

Transmitting 3005 corresponds to signaling 1005 described in relation to FIG. 2 herein, and/or receiving S209 described in relation to FIG. 5 herein. In one or more example methods, sending S3005 is performed upon the power level being equal to or below the power threshold. In one or more example methods, sending S3005 is not performed upon the power level being above the power threshold.

FIG. 7 shows a block diagram of an example first wireless device 300 according to the disclosure. The first wireless device 300 comprises memory circuitry 301, processor circuitry 302, and a wireless interface 303. The first wireless device 300 may be configured to perform any of the methods disclosed in FIG. 4. In other words, the first wireless device 300 may be configured for sidelink communication.

The first wireless device 300 is configured to communicate with a network node and/or with a second wireless device, such as the second wireless device 300A disclosed herein, using a wireless communication system.

The first wireless device 300 is configured to receive (e.g., using the processor circuitry 302 and/or using the wireless interface 303) a power signal indicative of a power level for sidelink communication within the first sidelink group.

The first wireless device 300 is configured to transmit (e.g., using the processor circuitry 302 and/or using the wireless interface 303) a sidelink signal within the first sidelink group. The first wireless device 300 is configured to transmit the sidelink signal according to the power signal, such as according to the indicated power level.

The first wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands or unlicensed bands, such as device-to-device millimeter-wave communications in licensed bands or unlicensed bands.

The first wireless device 300 is optionally configured to perform any of the operations disclosed in FIG. 4 (such as any one or more of S101, S103, S104, S104A, S104B, S105). The operations of the first wireless device 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the first wireless device 300 may be considered a method that the first wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information, such as a power signal, a power level, a sidelink group identifier, a sidelink signal, and location information, in a part of the memory.

FIG. 8 shows a block diagram of an example network node 400 according to the disclosure. The network node 400 comprises memory circuitry 401, processor circuitry 402, and an interface 403, such as a wired and/or wireless interface. The network node 400 may be configured to perform any of the methods disclosed in FIG. 5. In other words, the network node 400 may be configured for enabling sidelink communication.

The network node 400 is configured to communicate with a first WD and/or a second WD using a wireless communication system.

The interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands or unlicensed bands, such as device-to-device millimeter-wave communications in licensed bands or unlicensed bands.

The network node 400 is configured to receive (e.g., using the processor circuitry 402 and/or using the interface 403) position information indicative of a position of one or more wireless devices associated with a first sidelink group.

The network node 400 is configured to determine (e.g., using the processor circuitry 402), based on the position information, a power level for sidelink communication within the first sidelink group.

The network node 400 is configured to transmit (e.g., using the processor circuitry 402 and/or interface 403), to the first WD of the one or more WDs within the first sidelink group, a power signal indicative of the power level for sidelink communication within the first sidelink group.

Processor circuitry 402 is optionally configured to perform any of the operations disclosed in FIG. 5 (such as any one or more of S203, S205, S205A, S205B, S207, S209, S210, S211). The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 8). Memory circuitry 401 is considered a non-transitory computer readable medium.

Memory circuitry 401 may be configured to store information, such as position information, a power level, a power signal, a feedback signal, a sidelink group identifier, and an adjusted power level, in a part of the memory.

FIG. 9 shows a block diagram of an example second wireless device 300A according to the disclosure. The second wireless device 300A comprises memory circuitry 301A, processor circuitry 302A, and a wireless interface 303A. The second wireless device 300A may be configured to perform any of the methods disclosed in FIG. 6. In other words, the second wireless device 300A may be configured for sidelink communication.

The second wireless device 300A is configured to communicate with a network node and/or with a first wireless device, using a wireless communication system.

The second wireless device 300A is configured to receive (e.g., using the processor circuitry 302A and/or the wireless interface 303A) a sidelink signal from the first WD.

The second wireless device 300A is configured to send (e.g., using the processor circuitry 302A and/or the wireless interface 303A), to the network node, a feedback signal indicative of a power of the received sidelink signal.

The wireless interface 303A is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands or unlicensed bands, such as device-to-device millimeter-wave communications in licensed bands or unlicensed bands.

The second wireless device 300A is optionally configured to perform any of the operations disclosed in FIG. 6 (such as any one or more of S3001, S3003, S3004, S3005). The operations of the second wireless device 300A may be embodied in the form of executable logic routines (for example, lines of code, software programs, etc.) that are stored on a non-transitory computer readable medium (for example, memory circuitry 301A) and are executed by processor circuitry 302A.

Furthermore, the operations of the second wireless device 300A may be considered a method that the second wireless device 300A is configured to carry out. Also, while the described functions and operations may be implemented in software, such functionality may also be carried out via dedicated hardware or firmware, or some combination of hardware, firmware and/or software.

Memory circuitry 301A may be one or more of a buffer, a flash memory, a hard drive, a removable media, a volatile memory, a non-volatile memory, a random access memory (RAM), or any other suitable device. In a typical arrangement, memory circuitry 301A may include a non-volatile memory for long term data storage and a volatile memory that functions as system memory for processor circuitry 302A. Memory circuitry 301A may exchange data with processor circuitry 302A over a data bus. Control lines and an address bus between memory circuitry 301A and processor circuitry 302A also may be present (not shown in FIG. 9). Memory circuitry 301A is considered a non-transitory computer readable medium.

Memory circuitry 301A may be configured to store information, such as a sidelink signal, a feedback signal, a sidelink group identifier, a power signal, and a power level, in a part of the memory.

Examples of methods and products (first wireless device, network node and second wireless device) according to the disclosure are set out in the following items:
Item 1. A method, performed by a first wireless device, WD, for sidelink communication, wherein the first WD is within a first sidelink group of a plurality of sidelink groups, the method comprising:
   receiving (S103) a power signal indicative of a power level for sidelink communication within the first sidelink group; and
   transmitting (S105) a sidelink signal within the first sidelink group, wherein the sidelink signal is transmitted according to the power signal.
Item 2. The method according to Item 1, wherein the method comprises:
   adjusting (S104), based on the power signal, a power for transmission of the sidelink signal within the first sidelink group.
Item 3. The method according to any one of the Items 1 or 2, wherein the method comprises:
   transmitting (S101), to a network node, location information indicative of a location of the first wireless device.
Item 4. The method according to any one of Item 1 to 3, wherein the power signal is received from a network node.
Item 5. The method according to any one of Item 1 to 3, wherein the power signal is received from a second WD.
Item 6. The method according to Item 5, wherein the power signal is a reference signal.
Item 7. The method according to Item 6, wherein adjusting (S104) comprises
   determining (S104A), based on the reference signal, a path loss, and
   adjusting (S104B), based on the determined path loss, the power level for sidelink communication within the first sidelink group.
Item 8. The method according to any one of the Items 1 to 5, wherein the power signal is a request to adjust a power for transmission of the sidelink signal.
Item 9. The method according any one of the previous Items, wherein the power signal is indicative of one or more of an actual power level and a maximum power level for sidelink communication.
Item 10. The method according any one of the previous Items, wherein the power signal is indicative of a sidelink group identifier.
Item 11. A method, performed by a network node, for enabling sidelink communication, the method comprising:
   receiving (S203) position information indicative of a position of one or more wireless devices, WDs, associated with the first sidelink group;
   determining (S205), based on the position information, a power level for sidelink communication within the first sidelink group; and
   transmitting (S207), to a first WD of the one or more WDs within the first sidelink group, a power signal indicative of the power level for sidelink communication within the first sidelink group.
Item 12. The method according to Item 11, wherein determining (S205) comprises:
   calculating (S205A), based on the position information, a path loss, and
   determining (S205B), based on the calculated path loss, the power level for sidelink communication within the first sidelink group.
Item 13. The method according to any of the Items 11 to 12, wherein the method comprises:
   receiving (S209), from a second WD of the one or more WDs, a feedback signal indicative of a power of a received signal from the first WD, and
   transmitting (S211), to the first WD, an adjusted power level for sidelink communication within the sidelink group based on the feedback signal.
Item 14. The method according to Item 13, wherein the second WD is within the first sidelink group.
Item 15. The method according to Item 13, wherein the second WD is outside the first sidelink group.
Item 16. The method according to any of the Items 13 to 15, wherein the method comprises:
   determining (S210), based on the feedback signal, the adjusted power level for sidelink communication within the first sidelink group.
Item 17. The method according any one of the Items 11 to 16, wherein the power signal is indicative of one or more of an actual power level and a maximum power level for sidelink communication within the first sidelink group.
Item 18. The method according any one of the Items 11 to 17, wherein the power signal is indicative of a sidelink group identifier.
Item 19. A method, performed by a second wireless device, WD, for sidelink communication, the method comprising:
   receiving (S303), from a first WD, a sidelink signal, and
   sending (S305), to a network node, a feedback signal indicative of a power of the received sidelink signal.
Item 20. The method according to Item 19, wherein the method comprises:
   determining (S304) whether a power level of the sidelink signal is equal to or below a power threshold, and wherein sending (S305) is performed upon the power level being equal to or below the power threshold.
Item 21. The method according to Item 19 or 20, wherein the method comprises:
   transmitting (S301), to the first WD, a power signal indicative of a power level for sidelink communication within the first sidelink group.
Item 22. The method according to Item 21, wherein the power signal is a reference signal.
Item 23. The method according to any of the Items 19 to 22, wherein the feedback signal is indicative of a sidelink group identifier.
Item 24. A first wireless device comprising memory circuitry, processor circuitry, and a wireless interface, wherein the first wireless device is configured to perform any of the methods according to any of Items 1-10.
Item 25. A network node comprising memory circuitry, processor circuitry, and a wireless interface, wherein the network node is configured to perform any of the methods according to any of Items 11-18.
Item 26. A second wireless device comprising memory circuitry, processor circuitry, and a wireless interface, wherein the second wireless device is configured to perform any of the methods according to any of Items 19-23.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 9 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a first wireless device (WD) for sidelink communication, wherein the first WD is within a first sidelink group of a plurality of sidelink groups, the method comprising:
receiving a power signal indicative of a power level for sidelink communication within the first sidelink group; and
transmitting a sidelink signal within the first sidelink group, wherein the sidelink signal is transmitted according to the power signal.

2. The method according to claim 1, wherein the method comprises:
adjusting, based on the power signal, a power for transmission of the sidelink signal within the first sidelink group.

3. The method according to claim 1, wherein the method comprises:
transmitting, to a network node, location information indicative of a location of the first wireless device.

4. The method according to claim 1, wherein the power signal is received from a network node.

5. The method according to claim 1, wherein the power signal is received from a second WD.

6. The method according to claim 5, wherein the power signal is a reference signal.

7. The method according to claim 6, wherein adjusting comprises:
determining, based on the reference signal, a path loss, and
adjusting, based on the determined path loss, the power level for sidelink communication within the first sidelink group.

8. The method according to claim 1, wherein the power signal is a request to adjust a power for transmission of the sidelink signal.

9. The method according to claim 1, wherein the power signal is indicative of one or more of an actual power level and a maximum power level for sidelink communication.

10. The method according to claim 1, wherein the power signal is indicative of a sidelink group identifier.

11. A method, performed by a network node, for enabling sidelink communication, the method comprising:
receiving position information indicative of a position of one or more wireless devices (WDs) associated with the first sidelink group;
determining, based on the position information, a power level for sidelink communication within the first sidelink group; and
transmitting, to a first WD of the one or more WDs within the first sidelink group, a power signal indicative of the power level for sidelink communication within the first sidelink group.

12. The method according to claim 11, wherein determining comprises:
calculating, based on the position information, a path loss, and
determining, based on the calculated path loss, the power level for sidelink communication within the first sidelink group.

13. The method according to claim 11, wherein the method comprises:
receiving, from a second WD of the one or more WDs, a feedback signal indicative of a power of a received signal from the first WD, and
transmitting, to the first WD, an adjusted power level for sidelink communication within the sidelink group based on the feedback signal.

14. The method according to claim 13, wherein the second WD is within the first sidelink group.

15. The method according to claim 13, wherein the second WD is outside the first sidelink group.

16. The method according to claim 13, wherein the method comprises:
determining, based on the feedback signal, the adjusted power level for sidelink communication within the first sidelink group.

17. The method according to claim 11, wherein the power signal is indicative of one or more of an actual power level and a maximum power level for sidelink communication within the first sidelink group.

18. The method according to claim 11, wherein the power signal is indicative of a sidelink group identifier.

19. A method, performed by a second wireless device (WD) for sidelink communication, the method comprising:
receiving, from a first WD, a sidelink signal, and
sending, to a network node, a feedback signal indicative of a power of the received sidelink signal.

20. The method according to claim 19, wherein the method comprises:
determining whether a power level of the sidelink signal is equal to or below a power threshold, and wherein sending is performed upon the power level being equal to or below the power threshold.

21-26. (canceled)
